(19) United States
(12) Patent Application Publication
(10) Pub. No.: US 2021/0162430 A1
(43) Pub. Date: Jun. 3, 2021

(54) Anti-Drip Rotatable Sprayer

(71) Applicant: You-Sheng Wang, Minxiong Township (TW)

(72) Inventors: Yun-Han Chen, Minxiong Township (TW); Kuan-Jen Chen, Minxiong Township (TW); Yi-Chung Chen, Minxiong Township (TW)

(21) Appl. No.: 16/699,931

(22) Filed: Dec. 2, 2019

(51) Int. Cl. B05B 3/04; B05B 1/28

(52) U.S. Cl. CPC B05B 3/0463; B05B 1/28

(57) ABSTRACT

The present utility model provides an anti-drip rotatable sprayer, which is characterized in that: an inlet pipe and an outlet pipe are interconnected to pass through two opposite sides of the sprayer on the casing, the casing is provided with a reduction gear set driven by the driving shaft lever passing through the casing. The driving shaft lever passing through the casing is provided with a turntable, the inlet pipe passing through is provided with a nozzle to spray the water column towards the turntable, the turntable drives the reduction shaft lever and interlocks the outlet pipe to rotate on the casing. The sprayer is installed in a casing, the casing is provided with an external water source access passage for connecting the inlet pipe sprayer, and the casing is also provided with an outlet pipe through-outlet for passing through the outlet pipe of the sprayer. The outlet pipe after passing through the casing is connected to a spray head set, and the lower part of the casing is provided with a discharge outlet. The present utility model not only improves the overall spraying effect that the water mist after spraying the turntable is accumulated to form the water drips, and also it can be recycled.

### BACKGROUND OF INVENTION

### 1. Field of the Invention

The present utility model relates generally to an anti-drip structure of a rotatable sprayer which is provided with an inlet pipe for supplying a high-pressure water source, an outlet pipe for sending high-pressure water, and a sprayer for rotating the turntable to drive the outlet pipe by the nozzle, all of them are disposed in a casing; also, the high-pressure water source is connected to the inlet pipe through the casing, the outlet pipe passes through the casing and it is connected to a spray head set, and a discharge outlet is opened at a lower position inside the casing, so that the water after the turntable is rotated by the nozzle can be collected by the casing and recycled by the discharge outlet, without affecting the spray effect of the sprayer.

### 2. Description of Related Art

The rotary sprayer for heat dissipation in a large-area environment is that the water of a high-pressure water source is sprayed by a self-rotating sprayer to continuously swirl the water in a mist, as announced in Taiwan, No. 337058, 190737, 180358, 162578, 146292, 126858, 110205 and 090364 prior art patent, wherein Taiwan No. 110205 Patent is taken as an example (https://twpat5.tipo.gov.tw/tipotwochipotwkm?! !FR_110205), it discloses that the high-pressure water source emits the water column through the nozzle 60, impacts the atomized turntable 20 to be rotated, and then drives the driving shaft lever 23 of the atomized turntable 20, and the reduction gear set provided in the casing 10 (FIGS. 23, 31 and 51, that is, the transmission mechanism of the present utility model) drives the casing 10 disposed on the inlet pipe 50 for self-rotating; also, the upper end of the inlet pipe 50 is connected to the nozzle 60 and the spray head 75; thus, the atomized turntable 20 is rotated by the impact of the water column emitted by the high-pressure water source through the nozzle 60, and then it is self-rotated by the deceleration of the internal transmission mechanism of the casing 10; also or No. 190737 patent announced by Taiwan (log in: https://twpat5.tipo.gov.tw/tipotwochipotwkm?!!FR_190737), it is also equipped with a reduction gear set in the casing 10 (shown as in FIGS. 12, 13, 14, 15 and 16), and the final gear of the reduction gear is engaged with the gear 171 fixed on the fixed shaft 17, and then the driving shaft lever 16 is rotated by the turntable 23 through the nozzle 21, and the reduction gear set is driven by the driving shaft lever 16, finally, the final gear is rotated roundly on the gear 171, so that the entire casing 10 is rotated by taking the fixed shaft 3 as the center, and further the spray set is rotated to spray.

Said water mist sprayed by the spray head or the spray set has an excellent atomization effect, so that the water mist has an excellent heat absorption effect, and the evaporation speed is also fast, so that it has no the accumulate water drips. In addition, the main purpose of impacting the turntable is that the whole casing can drive the spray set to be rotated, and also the water column of the impacting the turntable can be atomized and rotated at the same time, however, no matter how the structure of the turntable impacted by water is designed, the water mist particles formed by the impact will be larger than the atomized particles of the spray head. It is difficult to achieve the refining effect of the spray head on the water, the water mist particles are large and uneven since the atomization effect is not good, so that the water mist particles are easily accumulated to form larger water mist particles, thereby causing that the water mist particles are easily adhered to the objects and accumulated to form water drips, which is the biggest existing problem that the rotary sprayer can't overcome it so far.

Therefore, although said sprayer has the effect of cooling down and cooling the environment of the site, but the water mist of the environment is accumulated to form water drips, so that the floor is wet and slippery, especially in the courtyard restaurant for outdoor dining Because the water drips on the food, it raises doubts about the hygiene of the food, and also makes the people inside the site feel the effects of moisture and discomfort.

### SUMMARY OF THE INVENTION

Therewith, in order to improve the refining effect of the high-pressure spray head that cannot be obtained by the water mist generated by said rotary sprayer to atomized the turntable through the water column, so that the water mist is easily accumulated to form the water drips, and the present utility model provides a casing with a discharge outlet at the bottom, an inlet pipe of the high-pressure water source can be covered with the sprayer of the outlet pipe that can discharge the water and rotate, and the sprayer's outlet pipe passes through the outer casing and then connected to the spray head set, and the water source can be connected to the inlet pipe through the casing, so that the water after rotating the turntable is left in the casing, and then discharged from the discharge outlet of the casing, so as to prevent the non-refined water mist from scattering, so that it is accumulated and discharged for recycling, further the spray environment will have no the problem of wet dripping.

The technical solution adopted by the present utility model to solve the technical problems thereof is:

An anti-drip rotatable sprayer is characterized in that: an inlet pipe and an outlet pipe pass through two opposite sides of a sprayer and they are interpenetrated, and a reduction gear driven by a driving shaft lever passing through the casing is provided in the casing, the driving shaft lever passing through the casing is mounted with a turntable, and the inlet pipe passing through the casing is connected to a nozzle that emits the water column towards the turntable. The turntable drives the driving shaft lever and the reduction gear set is connected with the outlet pipe and rotated on the casing. The sprayer is installed in a casing. The casing is provided with a water source access passage for connection of the sprayer's inlet pipe, and the casing is provided with a through-outlet for the outlet pipe of the sprayer to pass through. The outlet pipe after passing through the casing is connected with a spray head set. The lower part of the casing is provided with a discharge outlet.

The casing is also provided with a water source string-connection channel which is connected to the water source access channel and is connected with external water source.

The lower part of the casing is also provided with a row of the discharge string interface.

Therefore, the sprayer is installed inside the casing of the present utility model, so that the water after spraying the turntable is not spilled and collected in the casing, which will not affect the spray effect of the environment, and also will have no drip while the water collected in the casing can be discharged and reused after being discharged from the discharge outlet.

### BRIEF DESCRIPTION OF THE DRAWINGS

FIG. 1 is an appearance three-dimensional schematic diagram of the present utility model.

FIG. 2 is a top three-dimensional decomposition schematic diagram of the present utility model.

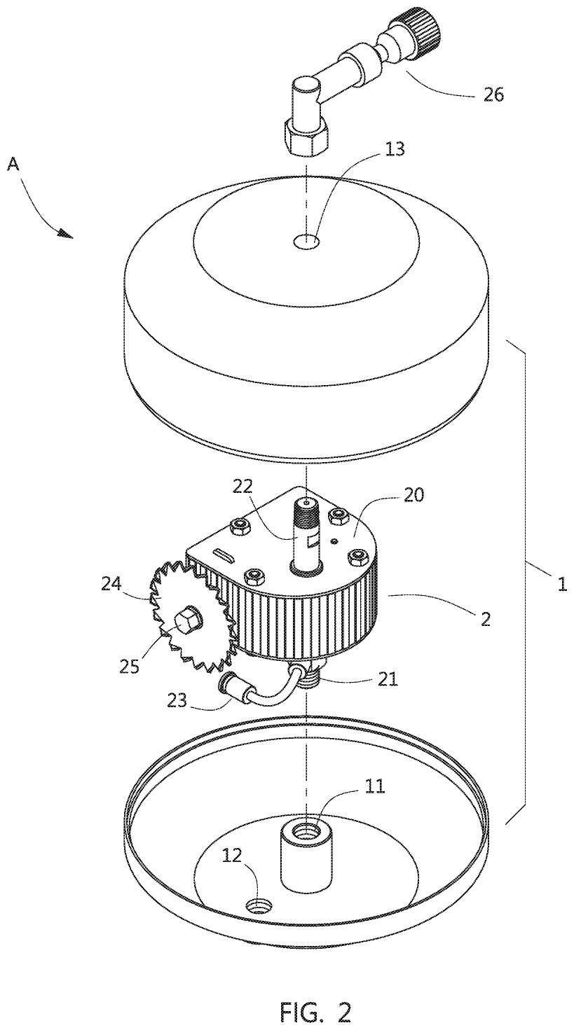

FIG. 3 is an upward three-dimensional decomposition schematic diagram of the present utility model.

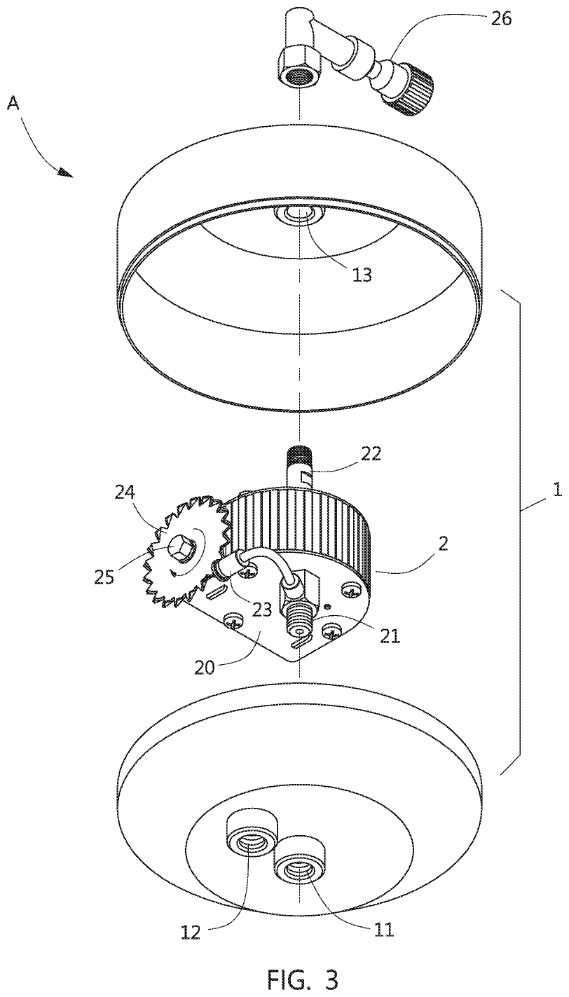

FIG. 4 is a sectional schematic diagram of the present utility model.

FIG. 5 is an appearance three-dimensional schematic diagram of the embodiment 2 of the present utility model.

FIG. 6 is a top three-dimensional decomposition schematic diagram of the embodiment 2 of the present utility model.

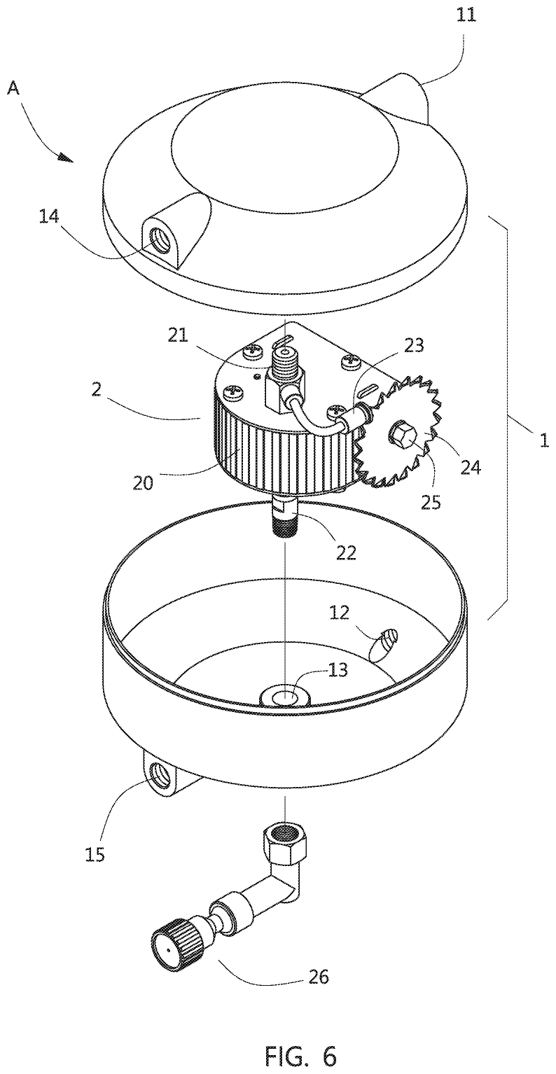

FIG. 7 is an upward three-dimensional decomposition schematic diagram of the embodiment 2 of the present utility model.

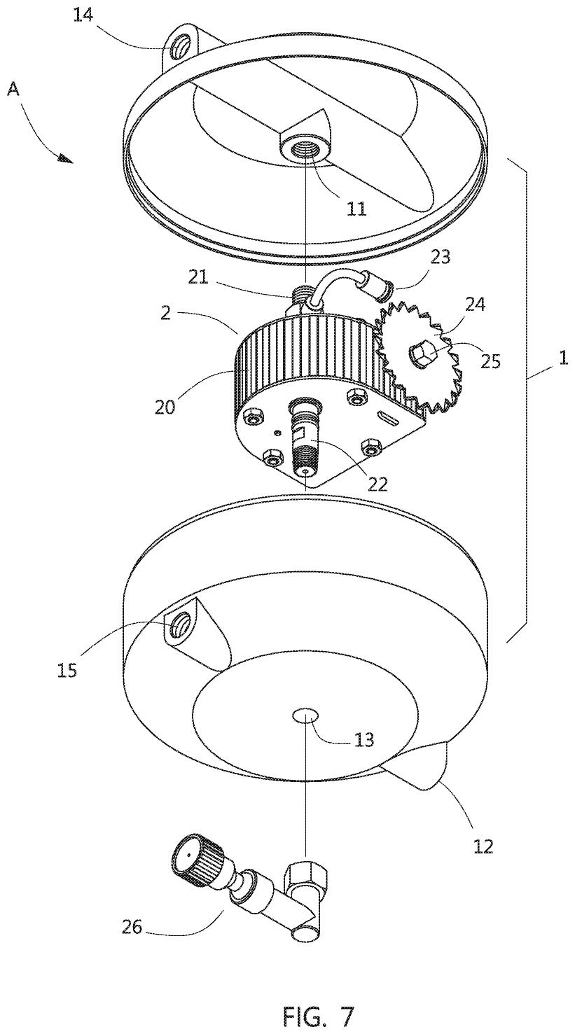

FIG. 8 is a sectional schematic diagram of the embodiment 2 of the present utility model.

FIG. 9 is a schematic diagram of the tandem connection use of the embodiment 2 of the present utility model.

Notes to the attached figures: A—sprayer; 1—casting; 11—water access channel; 12—discharge outlet; 13—outlet pipe through-outlet; 14—water source tandem connection channel; 15—discharge string interface; 2—sprayer; 21—inlet pipe; 22—outlet pipe; 23—nozzle; 24—turntable; 25—driving shaft left; 26—spray head set; 3—water source pipe; 4—discharge pipe.

### SPECIFIC IMPLEMENTATION MODE

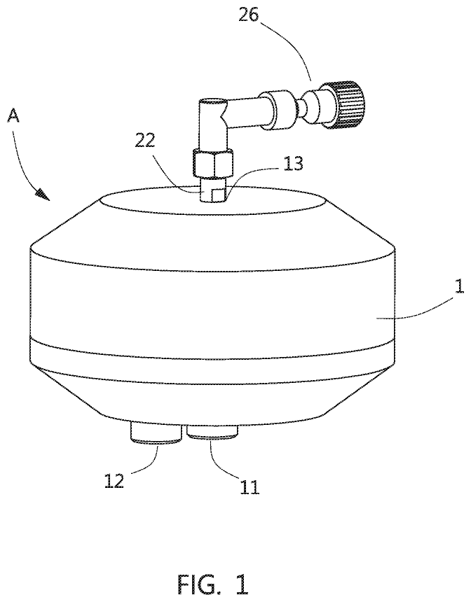

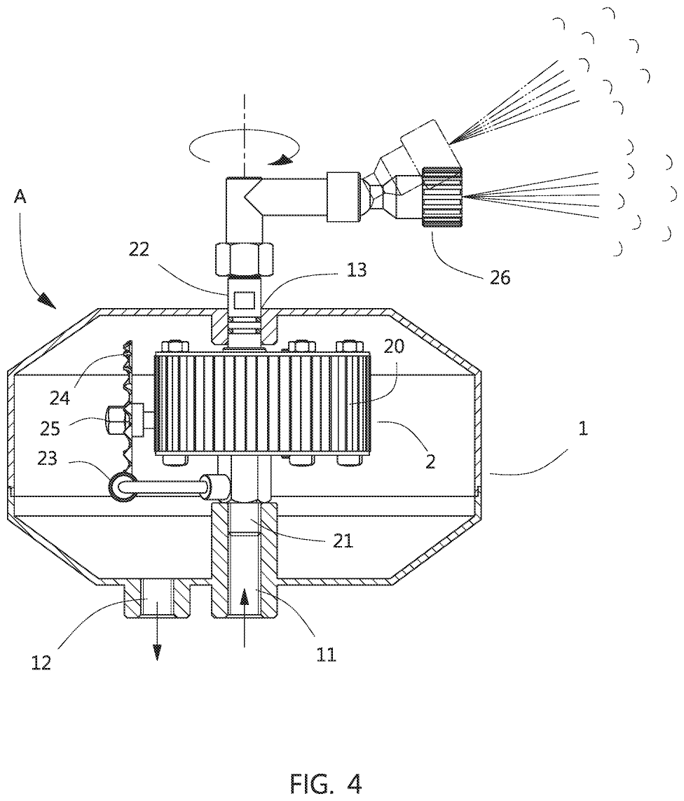

Referring to FIG. 1˜FIG. 4, the sprayer A of the present utility model is mainly provided with a sprayer 2, and the sprayer 2 is installed in a casing 1, and the outlet pipe 22 of the sprayer 2 is extended beyond the casing 1 and then connected with a spray head set 26, and a water source access channel 11 is disposed on the casing 1, so that the high-pressure water source can be connected into the sprayer 2, and also the lower part of the casing 1 can be provided with a discharge outlet for discharging the water.

Said sprayer 2, which is a prior art structure, includes a casing 20 with a reduction gear set therein, and two interconnected inlet pipes 21 (here, the sprayer's outlet pipe of the background art) and an outlet pipe 22 (here, the sprayer's inlet pipe of the background art) pass through the two opposite sides inside the casing 20, and then a driving shaft lever 25 passes through the casing 20, and a turntable 24 is installed at the pass-through position of the driving shaft lever 25, the pass-through inlet pipe 21 is further connected with a nozzle 23 which sprays the water column towards the turntable 24, and the turntable 24 is sprayed by the nozzle 23 to drive the driving shaft lever 25, and then the driving shaft lever 25 drives the reduction gear set in the casing 20, and the reduction gear set drives the outlet pipe 22 to rotate in the casing 20; in short, the turntable 24 of the sprayer 2 is sprayed to drive the outlet pipe 22 to rotate in the casing 20, but casing 20 itself is fixed.

In said casing 1, the corresponding position of the inlet pipe 21 of the sprayer 2 is connected with an external water source access passage 11, and the inlet pipe 21 can be connected to the passage port of the water source access passage 11, and said discharge outlet 12 is disposed at the lower part of the casing 1. In addition, an outlet pipe through-outlet 13 for passing through the outlet pipe 22 on the casing corresponding to the outlet pipe 22 of the sprayer 2, that is, the pass-through outlet pipe 22 is connected with the spray head set 26.

Therefore, the high-pressure water source is connected to the inlet pipe 21 of the sprayer 2 through the water source access passage 11 of the casing 1, so that the water is sprayed out of the water column by the nozzle 23 to rotate the turntable 24, and the outlet pipe 22 is rotated by the reduction gear set, and the high-pressure water is also flowed into the outlet pipe 22 via the inlet pipe 21, and then the high-pressure water is sprayed out from the spray head set 26 in a misty manner to absorb the heat and cool the environment, and it can be quickly dissipated and evaporated, and the water mist after the turntable 24 is sprayed by the nozzle 23 is collected by the casing 1 and not spilled, but it is accumulated to for the water, and then the accumulated water can be discharged from the discharge outlet 12 of the casing 1, not only the accumulated water can be recycled through the connected pipeline, but also the water after spraying the turntable 23 will not be dripped, except that it does not affect the original atomization effect of the spray head set 26, and keeps the environment clean and no wet slippery.

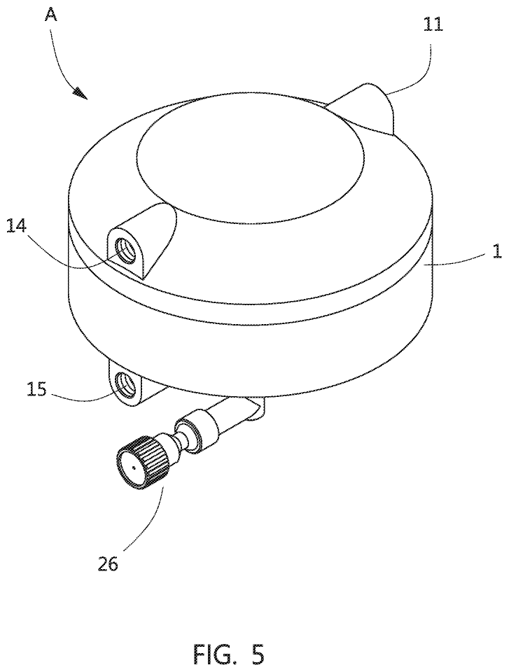

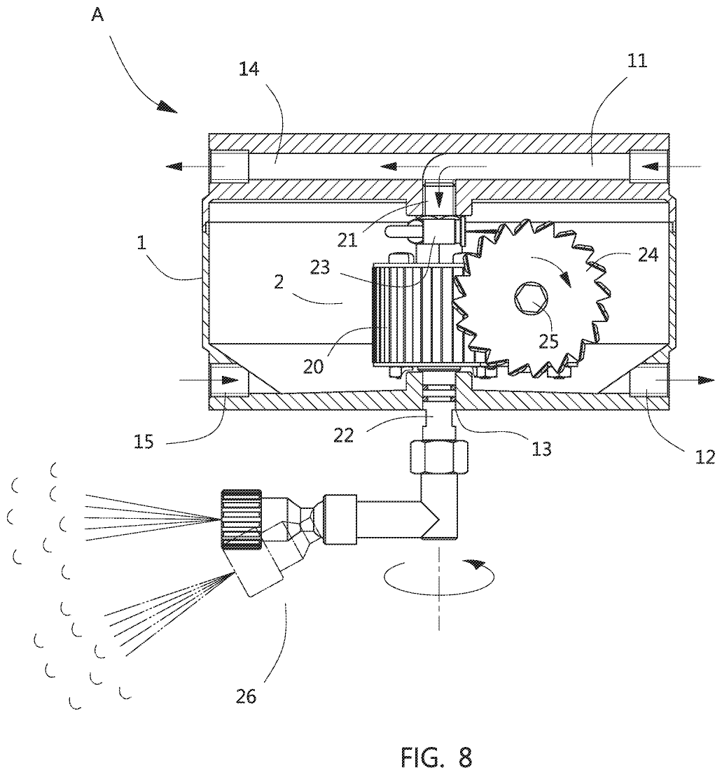

Said sprayer A is rotated upwards to spray in a standing mode, and if it is rotated downwards to spray, its structure is as shown in FIG. 5˜FIG. 8, and also the sprayer 2 is installed in a casing 1, so that the outlet pipe 22 of the sprayer 2 passes through the outlet pipe through-outlet 13 on the bottom surface of the casing 1, it is connected with a spray head set 26, and a discharge outlet 12 is also disposed at the bottom of the casing 1; the inlet pipe 21 of the sprayer 2 is connected to the water source access channel 11 provided at the top of the casing 1, so when the high-pressure water source is connected to the inlet pipe 21 of the sprayer 2 through the external water source access channel 11, the water column emitted by the nozzle 23 impacts the turntable 24, and then the outlet pipe 22 is rotated by the reduction gear set. The high-pressure water source will also be flowed into the outlet pipe 22 via the inlet pipe 21, and then the water mist is sprayed out at the spray head set 26, so that the casing 1 can collect and reuse the water after spraying the turntable 24, which will not affect the atomization effect of the spray head set 26 to achieve the same purpose and effect, further the casing 1 is provided with a water source serial-connection passage 14 connected with the water source access passage 11, and the lower part of the casing 1 is provided with a row of a water string interface 15.

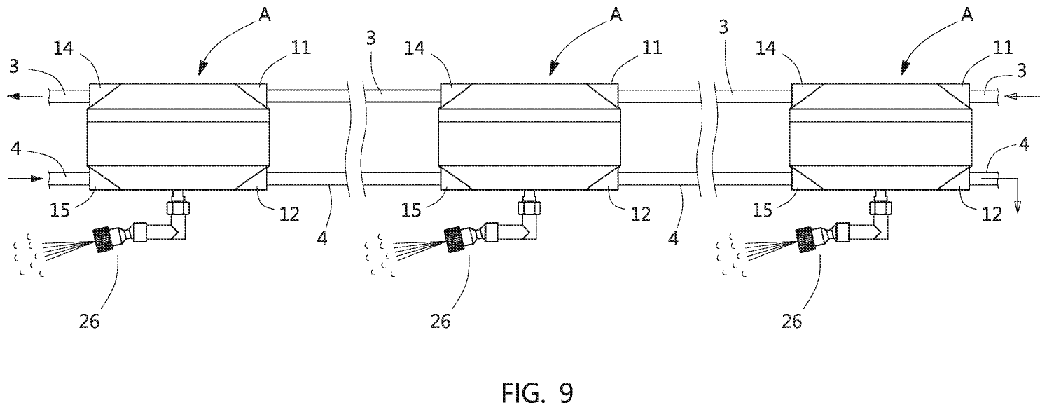

Therefore, as shown in FIG. 9, the sprayer A can supply the high-pressure water by connecting the several sprayer A in series through the water source access passage 11 and the water source serial-connection passage 14, also the discharge outlet 12 and the water string interface 15 on each sprayer A are connected in series through the discharge pipe 4, the water after spraying the turntable 24 can be recycled.

Secondly, as for the structure of the sprayer A that sprays upwards the water in the vertical mode, the water source access passage 11 of the casing 1 can also be connected with the water source serial-connection passage and the water string interface, so that several vertical sprayers can be also rotated upwards and connected in series through the pipeline.

1. An anti-drip rotatable sprayer is characterized in that: an inlet pipe and an outlet pipe are interconnected to pass through two opposite sides on the casing of a sprayer, and a reduction gear set driven by a driving shaft lever through a casing is provided in the casing, the driving shaft lever through the casing is mounted with a turntable, and an inlet pipe of the casing is connected to a nozzle that emits the water column towards the turntable, and the turntable drives the driving shaft lever and interlocks the outlet pipe to rotate on the casing through the reduction gear set, the sprayer is installed in a casing, the casing is provided with an external water source access passage for connecting the inlet pipe of the sprayer, and the casing is also provided with an outlet pipe through-outlet for passing through the outlet pipe of the sprayer, and the outlet pipe passes through the casing and then is connected with a spray head set; the lower part of the casing is provided with a discharge outlet.

2. The structure defined in claim 1 is characterized in that: the casing is further provided with an external water source serial-connection passage connected with a water source access passage.

3. The structure defined in claim 1 is characterized in that: the lower part of the casing is further provided with a row of the water string interfaces.
